(19) United States
(12) Patent Application Publication
(10) Pub. No.: US 2002/0126047 A1
(43) Pub. Date: Sep. 12, 2002

(54) Planar inverted-F antenna

(76) Inventor: Steven J. Laureanti, Lewisville, TX (US)

Correspondence Address: COATS & BENNETT, PLLC, P O BOX 5, RALEIGH, NC, 27602, US

(21) Appl. No.: 09/800,849

(22) Filed: Mar. 7, 2001

(51) Int. Cl. H01Q 1/00; H01Q 1/24

(52) U.S. Cl. 343/700 MS; 343/702

(57) ABSTRACT

A planar inverted-F antenna comprises an antenna coupled to an antenna ground plane having a ground plane extension that is at least partially perpendicular to the plane of the antenna. The antenna structure comprises a modular unit that may be installed in a plurality of disparate devices without unduly changing the performance profile of the antenna at the desired operating frequencies.

### BACKGROUND OF THE INVENTION

The present invention relates to a modular inverted-F antenna well suited for deployment in Bluetooth modules.

Wireless communication devices have proliferated throughout modern society. Pagers and cell phones are now ubiquitous. Wireless enabled personal digital assistants are also becoming common. A new standard, known as the Bluetooth standard, has been propounded and would allow many disparate devices to communicate with one another. For example, the Bluetooth standard would allow mobile terminals to communicate wirelessly with printers, scanners, computers, and household appliances.

Wireless communication devices require antennas that radiate and receive electromagnetic signals. By their very nature, antennas are susceptible to many factors that affect the performance of the antenna. Exemplary factors include electromagnetic interference (EMI or crosstalk), impedance matching concerns, and the like. Additionally, the antenna is often placed into close proximity with a circuit board on which other electronic components and a ground plane are located. The electronic circuits and ground plane of the host device interact with the antenna structure and may degrade performance of the antenna. Typically, antenna designs for electronic devices are application specific and Bluetooth devices, in particular, may require significant development time to design a suitable antenna for each application to accommodate printed circuit board layout, component positioning, and other factors. This design and redesign process is inefficient and wasteful.

### BRIEF SUMMARY OF THE INVENTION

The present invention relates to antennas and more particular to planar inverted-F antennas for use in wireless communication devices. A planar inverted-F antenna is coupled to an antenna ground plane that is at least partially perpendicular to the plane in which the antenna lies. Another portion of the antenna ground plane is generally coplanar with the plane in which the antenna lies. Together the antenna and the antenna ground plane, with perpendicular extension, form a modular unit. This modular unit may be installed in a plurality of devices without unduly changing the performance profile of the antenna at the desired operating frequencies. In effect, the perpendicular portion of the antenna ground plane helps reduce interference that may be caused by components on the primary printed circuit board of the host device into which the antenna is placed.

### BRIEF DESCRIPTION OF THE DRAWINGS

FIG. 1 illustrates a schematic diagram of a Bluetooth enabled mobile terminal;

FIG. 2 illustrates a mobile terminal with an exemplary embodiment of an antenna according to the present invention installed therein;

FIG. 3 illustrates a top plan view of one embodiment of the planar inverted-F antenna of the present invention removed from a Bluetooth enabled device; and

FIG. 4 illustrates a partial side elevational view of the antenna of FIG. 3.

### DETAILED DESCRIPTION OF THE INVENTION

The present invention is directed to a modular antenna structure that can be placed in any of a plurality of host devices without the need to redesign the antenna structure to compensate for interference caused by electronic components within the host device. In particular, the present invention is well suited for use in Bluetooth devices.

The Bluetooth standard enables seamless communication of data and voice over short-range wireless links between both mobile devices and fixed devices. The Bluetooth standard permits ad hoc networking of devices equipped with a Bluetooth interface. Bluetooth devices operate in the Industrial-Scientific-Medical (ISM) frequency band at approximately 2.45 GHz. Different Bluetooth devices can automatically connect and link up with one another when they come into range to form an ad hoc network, generally referred to as a piconet. The Bluetooth standard specifies how mobile devices, such as phones, personal digital assistants (PDAs), and wireless information devices (WIDS), can interconnect with one another and with stationary devices, such as desktop computers, printers, scanners, and stationary phones.

As used herein, the term “Bluetooth device” means a device capable of communicating with other devices via short-range wireless link. Bluetooth devices may comprise many disparate types of devices, such as desktop or laptop computers, printers, scanners, computer input devices, other computer peripheral devices, mobile radiotelephones, other mobile terminals, or household appliances. Bluetooth devices may be fixed devices or mobile devices.

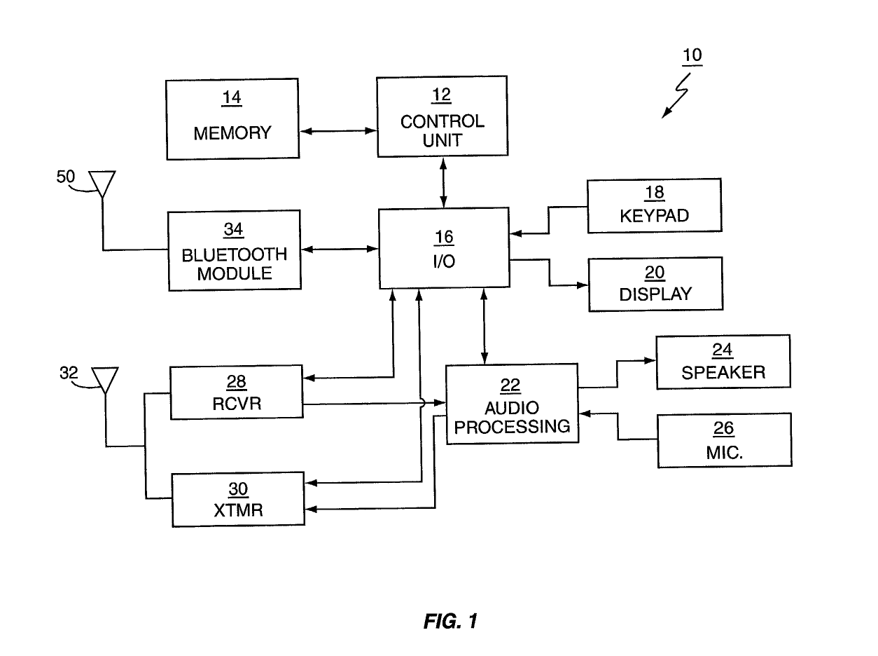

FIG. 1 is a block diagram of a mobile terminal 10 with a Bluetooth interface, which is one example of a Bluetooth device. It should be noted that the term “mobile terminal” 10 as used herein may include a cellular radiotelephone with or without a multi-line display; a Personal Communications System (PCS) terminal that may combine a cellular radiotelephone with data processing, facsimile and data communications capabilities; a Personal Digital Assistant (PDA) may include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals 10 may also be referred to as “pervasive computing” devices.

Mobile terminal 10 comprises a main control unit 12 for controlling the operation of the mobile terminal 10 and memory 14 for storing control programs and data used by the mobile terminal 10 during operation. Memory 14 may be contained in a removable smart card if desired. Input/output circuits 16 interface the control unit 12 with a keypad 18, display 20, audio processing circuits 22, receiver 28, and transmitter 30. The keypad 18 allows the operator to dial numbers, enter commands, and select options. The display 20 allows the operator to see dialed digits, stored information, and call status information. The audio processing circuits 22 provide basic analog audio outputs to a speaker 24 and accept analog audio inputs from a microphone 26. The receiver 28 and transmitter 30 receive and transmit signals using shared antenna 32. The mobile terminal 10 further includes a Bluetooth module 34 operating as previously described and having an antenna structure 50 operating in the ISM band according to the present invention.

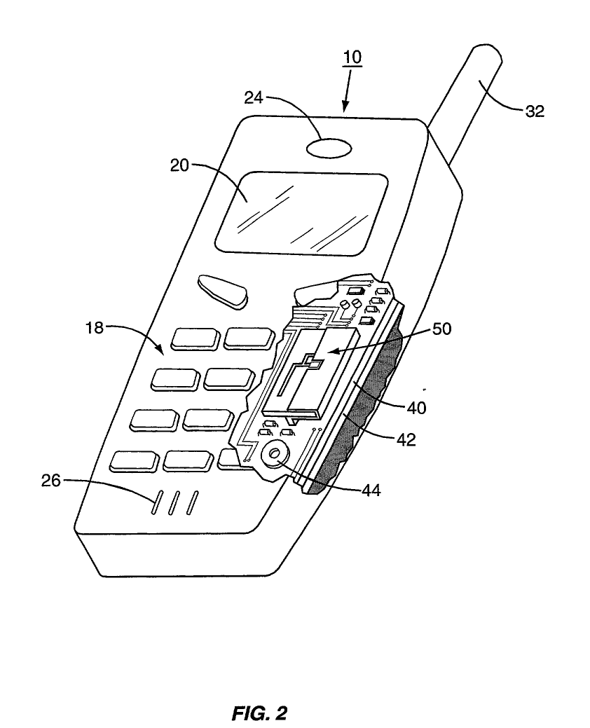

FIG. 2 illustrates an antenna structure 50 according to an exemplary embodiment of the present invention in a mobile terminal 10 (i.e., host device). The exact positioning of the antenna structure 50 will depend on the physical geometry of the circuit board layout and other factors and other positions internal to the mobile terminal 10 (or other host device) are contemplated. Note that this does not require the antenna structure 50 to be redesigned, but the actual positioning within the host device will of course, to some extent, be contingent upon the space available within the host device. As illustrated, mobile terminal 10 includes a printed circuit board 40 with ground plane 42 and various electronic components 44 disposed thereon. Electronic components 44 may comprise the Bluetooth module 34, control unit 12, memory 14, or other RF circuitry.

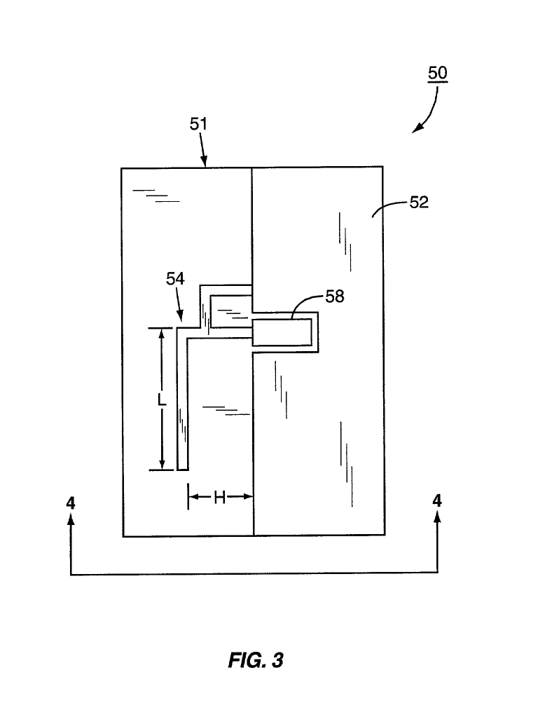

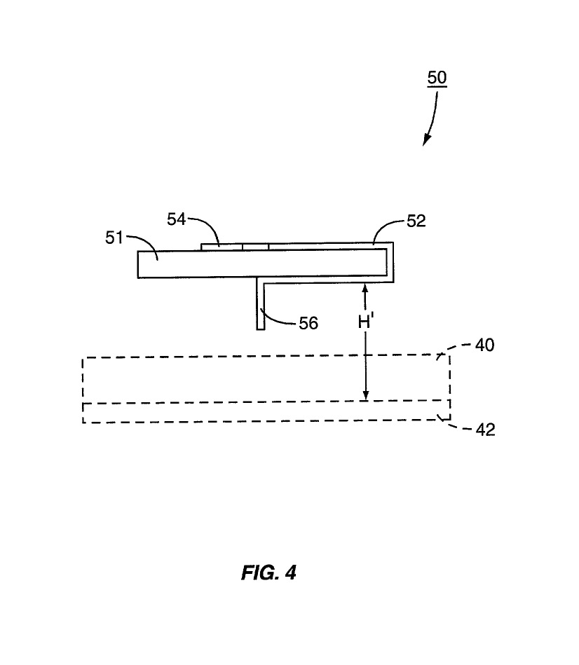

Antenna structure 50 is illustrated in more detail in FIGS. 3 and 4. In particular, antenna structure 50 is constructed as a unitary module that can be inserted into a host device, such as mobile terminal 10. Antenna structure 50 comprises a printed circuit board 51 with an antenna ground plane 52 disposed on a top surface and a bottom surface thereof. Antenna 54 is disposed on the top surface of printed circuit board 51 . Antenna 54 forms a planar inverted-F antenna, wherein the distance of L+H (FIG. 3) approximates a quarter wavelength of the operative frequency of the antenna structure 50. Antenna 54 may be terminated by launch 58 that acts as an electrical lead for the antenna 54. Planar inverted-F antenna 54 may be formed from conventional microstrip materials as is well understood.

Appropriate electrical connections may extend between electronic components 44 or circuit board 40 and antenna structure 50 as is well understood. For example, a coaxial cable (not illustrated) may be soldered with one lead to launch 58, and a second lead to ground plane 52. Alternatively, a surface mount device (SMA) may be soldered to the launch 58 and the coaxial cable connected thereto. Other devices, such as a snap may also be used. To the extent that launch 58 is a lead for the antenna 54, there is an open circuit between launch 58 and the ground plane 52.

As illustrated in FIG. 4, antenna ground plane 52 covers a substantial portion of the top and bottom surfaces of the printed circuit board 51. Antenna ground plane 52 includes an extension portion 56 that is perpendicular to planar inverted-F antenna 54 while other portions of antenna ground plane 52 are generally coplanar or parallel to the plane of the planar inverted-F antenna 54. In the disclosed embodiment, extension portion 56 extends the entire length of the antenna ground plane 52. Extension portion 56 may be realized in various manners, such as a metal component that is soldered to the printed circuit board 51, a small ground plane printed circuit board structure that is inserted into slots on the printed circuit board 51, or the like. In one embodiment, the extension portion 56 begins at the 50 ohm launch 58 to the planar inverted-F antenna 54.

The addition of extension portion 56 helps reduce interference that may be caused by other components within the host device. In use, the antenna structure 50 is positioned proximate the main printed circuit board 40 and ground plane 42 of the host device. Appropriate connections to electronic components 44, printed circuit board 40, and/or the host device ground plane 42 are made. The distance of antenna structure 50 from the host device ground plane 42 will vary depending upon the operating frequency and circuit board layout. This distance may, for example, be a quarter wavelength at the desired operating frequency. Because of its modular design, the antenna structure 50 need not be redesigned for each application. That is, the same modular antenna structure 50 may be effective in a broad range of applications.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. An antenna structure comprising:
a planar inverted-F antenna; and
a first ground plane proximate to and associated with said planar inverted-F antenna, at least a portion of said first ground plane disposed perpendicular to said planar inverted-F antenna.

2. The antenna structure of claim 1 further comprising a second ground plane spaced from said planar inverted-F antenna.

3. The antenna structure of claim 1 wherein said planar inverted-F antenna is optimized for operation at approximately 2.4 GHz.

4. The antenna structure of claim 1 wherein at least a portion of said first ground plane is generally coplanar with said planar inverted-F antenna.

5. The antenna structure of claim 1 wherein said antenna structure comprises a modular unit for installation in any of a plurality of devices.

6. The antenna structure of claim 1 wherein said antenna structure comprises a modular unit for installation in any of a plurality of Bluetooth devices substantially without modification.

7. An antenna structure comprising:
a printed circuit board;
a planar inverted-F antenna positioned on one side of said printed circuit board;
a ground plane comprising a first portion and an extension, said first portion positioned on said printed circuit board generally coplanar with said planar inverted-F antenna; and
said extension disposed perpendicular to said first portion and said planar inverted-F antenna.

8. The antenna structure of claim 7 wherein said antenna structure comprises a modular unit so as to fit in any of a plurality of devices.

9. The antenna structure of claim 7 wherein said antenna is operative in a frequency band near 2.4 GHz.

10. The antenna structure of claim 7 further comprising a second ground plane in a host device, said second ground plane proximate said first ground plane.

11. An electronic device comprising an RF circuit for wireless communication with other devices, said electronic device comprising:
a first printed circuit board with an RF circuit and a primary ground plane positioned thereon within the device; and
an antenna structure electrically connected to said RF circuit, said antenna structure comprising:
a planar inverted-F antenna; and
a second ground plane proximate to and associated with said planar inverted-F antenna, at least a portion of said second ground plane perpendicular to said planar inverted-F antenna; and
wherein said second ground plane is proximate to said primary ground plane.

12. The device of claim 11 wherein said device comprises a mobile terminal.

13. A method of isolating a planar inverted-F antenna from detrimental interference from a primary ground plane in a wireless device, said method comprising:
positioning a second ground plane proximate said planar inverted-F antenna with at least a portion of said second ground plane perpendicular to said planar inverted-F antenna.

14. The method of claim 13 wherein said wireless device is a Bluetooth device.
